(19) United States
(12) Patent Application Publication
(10) Pub. No.: US 2017/0049090 A1
(43) Pub. Date: Feb. 23, 2017

(54) Digital Sports Fishing

(71) Applicant: Eco Net Ltd., Hod Hasharon (IL)

(72) Inventor: Dani Zeevi, Hod Hasharon (IL)

(21) Appl. No.: 15/305,354

(22) PCT Filed: Apr. 28, 2015
(86) PCT No.: PCT/IB2015/053081

§ 371 Date: Oct. 20, 2016

Related U.S. Application Data
(60) Provisional application No. 61/992,236, filed on May 13, 2014.
(60) Provisional application No. 62/099,604, filed on Jan. 5, 2015.

(51) Int. Cl. A01K 97/12; A01K 85/16; A01K 85/08; G03B 17/08; H04W 4/00; H04N 7/18; G06T 7/00; A01K 85/01; A01K 93/02

(52) U.S. Cl. CPC A01K 97/125; A01K 85/01; A01K 85/16; A01K 85/08; A01K 93/02; H04W 4/008; H04N 7/183; G06T 7/0004; G03B 17/08

(57) ABSTRACT

Angling apparatus (20) includes an immersible sensing device (22, 50, 80, 90, 100), which is configured for attachment to a distal end of a fishing line (26) and contains one or more sensors (32, 34, 70, 73) and a wireless communication interface (62) coupled to transmit signals indicative of an output of the one or more sensors. In one embodiment, an antenna (38) has a first end connected to receive signals from the wireless communication interface, and which is configured to be attached collinearly to the fishing line so that while the sensing device is immersed below a surface of a body of water, a second end of the linear antenna, opposite the first end, protrudes above the surface in order to transmit the signals.

### CROSS-REFERENCE TO RELATED APPLICATIONS

This application claims the benefit of U.S. Provisional Patent Application 61/992,236, filed May 13, 2014, and of U.S. Provisional Patent Application 62/099,604, filed Jan. 5, 2015, both of which are incorporated herein by reference.

### FIELD OF THE INVENTION

The present invention relates generally to fishing equipment, and particularly to electronic devices, methods and systems for assisting and providing information to anglers.

### BACKGROUND

Line fishing, commonly known as angling, is one of the most popular recreational sports worldwide. An angler attaches either food bait or an artificial bait to the end of a fishing line, on or in proximity to a fishing hook, and casts or drops the line into the water. (Some types of artificial bait are also referred to as “lures.”) Depending on the type of fish that the angler seeks to catch, the bait and hook may be dropped deep under water, or they may be held and manipulated in proximity to the surface of the water, either on or slightly below the surface.

Traditionally, anglers have depended largely on intuition, rumors and simple chance in choosing where and how to fish. More recently, there have been a number of suggestions in the patent literature of electronic devices that attach to a fishing line for the purpose of assisting the angler. For example, PCT International Publication WO 2013/186576 describes a combination float for fishing and a video capture and data transmission system. The combination includes a semi-submersible elongated hollow float containing a battery-operated video camera and data transmitter. The transmitter is disposed within the upper part of the float above the waterline when the float is in use. The camera has its optical axis pointing downwardly below the waterline, with a viewing window in the bottom of the float through which the camera can view the local area of water within which the combination is floating. This arrangement is said to enable real-time video images to be captured and transmitted to a remote interface, such as a mobile phone.

U.S. Patent Application Publication 2014/0164375 (published Jun. 12, 2014) describes a system for gathering and assembling information based on data received from one or several mobile terminals. The data at least relates to a position, environmental information and a tool used by a user of the mobile terminal for carrying out an activity, such as fishing, hunting, sports, climbing or mushroom picking. A central processing unit is configured to process the data and assemble optimized data for carrying out the activity. An “app” on the mobile terminal can log fishing trips, catches and moments, and the data are stored in a database of a server.

### SUMMARY

Embodiments of the present invention that are described hereinbelow provide novel devices, methods and systems for collecting and providing information to anglers.

There is therefore provided, in accordance with an embodiment of the invention, angling apparatus, including an immersible sensing device, which is configured for attachment to a distal end of a fishing line and contains one or more sensors and a wireless communication interface coupled to transmit signals indicative of an output of the one or more sensors. A linear antenna has a first end connected to receive signals from the wireless communication interface, and is configured to be attached collinearly to the fishing line so that while the sensing device is immersed below a surface of a body of water, a second end of the linear antenna, opposite the first end, protrudes above the surface in order to transmit the signals.

In some embodiments, the immersible sensing device is configured as an artificial bait, such as a crankbait.

Typically, the one or more sensors include an image sensor, which is configured to capture images below the surface. Additionally or alternatively, the output of at least one of the sensors is indicative of a quality of the water. Further additionally or alternatively, at least one of the sensors includes an accelerometer.

In some embodiments, the wireless communication interface is configured to transmit the signals via the antenna over the air to a receiver using a short-range radio-frequency (RF) communication protocol. The apparatus may include a mobile computing device, which includes the receiver and is configured to process the signals and to provide, responsively to the processed signals, information to an angler operating the apparatus.

There is also provided, in accordance with an embodiment of the invention, angling apparatus, including an artificial bait, which is configured for immersion in water. The artificial bait includes a case, which has an appearance chosen to attract a fish in the water and is configured to be attached to a fishing line. A motion sensor is contained within the case and configured to generate an output indicative of motion of the artificial bait. A communication interface is contained within the case and coupled to transmit signals indicative of the output of the motion sensor.

In some embodiments, the apparatus includes a mobile computing device, which is configured to receive and process the signals transmitted by the communication interface so as to present an analysis of a trajectory of the artificial bait to an angler using the apparatus.

There is additionally provided, in accordance with an embodiment of the invention, angling apparatus, including an artificial bait, which is configured for immersion in water. The artificial bait includes a translucent case, which has an external appearance chosen to attract a fish in the water and is configured to be attached to a fishing line. A light source is contained inside the case, and is controllable to emit light having a variable aspect so as to change the external appearance of the case.

Typically, the variable aspect of the light source includes a variable color of the emitted light.

In some embodiments, the apparatus includes a communication interface, which is contained within the case and is coupled to receive command signals from a transmitter external to the artificial bait. A controller is coupled to alter the variable aspect of the light source responsively to the command signals.

Additionally or alternatively, the apparatus includes an acoustic transducer, which is contained inside the case and is configured to perform at least one of transmitting and receiving acoustic vibrations in the water.

There is further provided, in accordance with an embodiment of the invention, a system for angling, including at least one immersible sensing device, containing one or more sensors and a wireless communication interface coupled to transmit signals indicative of an output of the one or more sensors, for deployment at a distal end of a fishing line by an angler into a body of water. A processor is coupled to receive the signals transmitted by the at least one immersible sensing device over the air and to process the signals so as to present a recommendation with regard to the angling.

In a disclosed embodiment, the processor is contained in a mobile computing device, which is configured to receive the signals over the air from the at least one immersible sensing device.

In some embodiments, the at least one immersible sensing device is configured as an artificial bait. In one embodiment, at least one of the sensors includes an accelerometer, and the processor is configured to analyze a trajectory of the artificial bait and to present advice to the angler, responsively to the trajectory, with regard to an angling technique.

Additionally or alternatively, the one or more sensors include an image sensor, which is configured to capture images below the surface, and the processor is configured to process images of fish captured by the image sensor. In one embodiment, the processor is configured to direct the angler, based on the processed images, to a location for catching fish.

In a disclosed embodiment, the at least one immersible sensing devices includes multiple immersible sensing devices for deployment by multiple anglers at different, respective locations, and the processor is configured to receive data from the multiple immersible sensing devices and to process the images captured at the different locations so as to provide an indication of the location for catching fish.

Further additionally or alternatively, the output of at least one of the sensors is indicative of a quality of the water. In one embodiment, the at least one immersible sensing devices includes multiple immersible sensing devices for deployment by multiple anglers at different, respective locations, and the processor is configured to receive data from the multiple immersible sensing devices and to analyze the data so as to provide a map of environmental quality over an area containing the locations.

There is moreover provided, in accordance with an embodiment of the invention, a method for angling, which includes providing at least one immersible sensing device, containing one or more sensors and a wireless communication interface coupled to transmit signals indicative of an output of the one or more sensors, for deployment at a distal end of a fishing line by an angler into a body of water. The signals transmitted by the at least one immersible sensing device are received over the air in a mobile computing device carried by the angler. The signals are processed so as to present a recommendation with regard to the angling.

There is furthermore provided, in accordance with an embodiment of the invention, a method for angling, which includes attaching to a distal end of a fishing line an immersible sensing device containing one or more sensors and a wireless communication interface coupled to transmit signals indicative of an output of the one or more sensors. A first end of a linear antenna is connected to receive signals from the wireless communication interface. The linear antenna is attached collinearly to the fishing line so that while the sensing device is immersed below a surface of a body of water, a second end of the linear antenna, opposite the first end, protrudes above the surface in order to transmit the signals.

There is also provided, in accordance with an embodiment of the invention, a method for angling, which includes providing an artificial bait, which is configured for immersion in water and includes a case, which has an appearance chosen to attract a fish in the water and is configured to be attached to a fishing line, and a motion sensor, contained within the case and configured to generate an output indicative of motion of the artificial bait. Signals indicative of the output of the motion sensor are transmitted from the artificial bait to a receiver outside the water.

There is additionally provided, in accordance with an embodiment of the invention, a method for angling, which includes providing an artificial bait, which is configured for immersion in water and includes a translucent case, which has an external appearance chosen to attract a fish in the water and is configured to be attached to a fishing line. A light source, which is contained inside the case, is controlled to emit light having a variable aspect so as to change the external appearance of the case.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a digitally-assisted angling system, in accordance with an embodiment of the invention;

FIGS. 2A, 2B and 2C are schematic top, side, and bottom views, respectively, of an electronic artificial bait, in accordance with an embodiment of the invention;

FIG. 3 is a block diagram that schematically illustrates functional components of an electronic artificial bait, in accordance with an embodiment of the invention;

FIG. 4 is a schematic, pictorial illustration of an electronic float, in accordance with an embodiment of the invention;

FIG. 5 is a schematic, pictorial illustration of an electronic fly lure, in accordance with an embodiment of the invention;

FIG. 6 is a schematic, pictorial illustration of an electronic underwater sensing device, in accordance with an embodiment of the invention; and

FIG. 7 is a schematic, pictorial illustration of a system for electronic data collection, processing and exchange, in accordance with an embodiment of the invention.

### DETAILED DESCRIPTION OF EMBODIMENTS

Embodiments of the present invention that are described herein provide devices and methods that can enhance the angler's fishing experience in various ways. Some of these embodiments provide immersible sensing devices that can be attached to the distal end of a fishing line (i.e., the end that is cast or dropped into the water) and transmit signals with respect to the presence or absence of fish in the vicinity, as well as other water quality factors. The sensing devices are “immersible” in the sense that they operate while partially immersed in a body of water. In some embodiments, the sensing devices are configured as artificial bait or other fishing tackle, such as crankbait, poppers, fly lures, or floats, for example.

Typically, the disclosed sensing devices transmit their signals over a short-range wireless link to a mobile computing device, such as a smartphone or a tablet, carried by the angler, although other sorts of communication links may alternatively be used. An application running on the computing device processes the sensor outputs carried by the signals in order to provide information to the angler. This information may include, for example, recommendations regarding where to fish or how to improve the angler's fishing technique.

Some embodiments of the present invention take advantage of the deployment of multiple sensing devices by different anglers at different, respective locations to build a data collection and sensing network. The anglers' mobile computing devices transmit the data that they have collected from the respective sensors over a wide-area network, via a cellular data network, for example, to a server, which processes the data. By collating the data from multiple locations, the server can provide recommendations of fishing locations, as well as monitoring and mapping environmental quality factors, particularly water quality, over a wide area. The network of sensing devices that is established in this manner can be used both to provide useful information to anglers and to collect data for use in environmental monitoring, research and protection, as well as weather monitoring and forecasting. Such monitoring can be conducted in real time or offline.

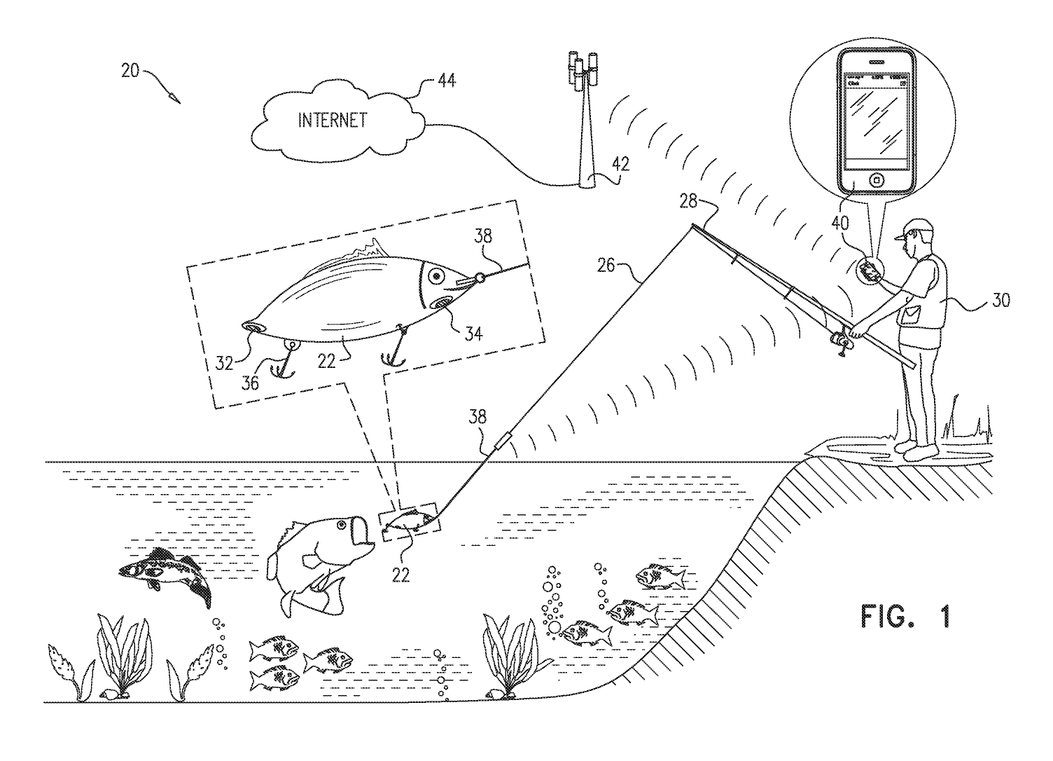

FIG. 1 is a schematic, pictorial illustration of a digitally-assisted angling system 20, in accordance with an embodiment of the invention. System 20 is built around an immersible sensing device 22, which is attached to the distal end of a fishing line 26. An angler 30 uses a fishing rod 28 to manipulate device 22 near the surface of a body of water. As illustrated in the inset, device 22 is typically configured as an artificial bait, with a hook or hooks 36, and contains one or more sensors, such as an image sensor 32 with suitable optics (not shown), which captures images below the surface of the water, and water quality sensors 34. In FIG. 1, device 22 is configured as a crankbait, which angler 30 trolls a short distance below the surface of the water. Other sensing device configurations are shown in the figures that follow, and the features of device 22 that are described hereinbelow can be implemented, mutatis mutandis, in these other device configurations, as well.

Device 22 contains a wireless communication interface (shown in the figures that follow), which transmits signals over the air to a mobile computing device 40, such as a smartphone, or other receiver, which is typically held or carried by angler 30. These signals are indicative of the outputs of sensors 32, 34, which include a digital still or video output from image sensor 32 and/or telemetric readings from sensors 34. The wireless link may also carry control inputs, configurations and instructions from device 40 to device 22. Devices 22 and 40 typically communicate over the wireless link using a short-range radio-frequency (RF) communication protocol, such as a Wi-Fi (IEEE 802.11) or Bluetooth protocol.

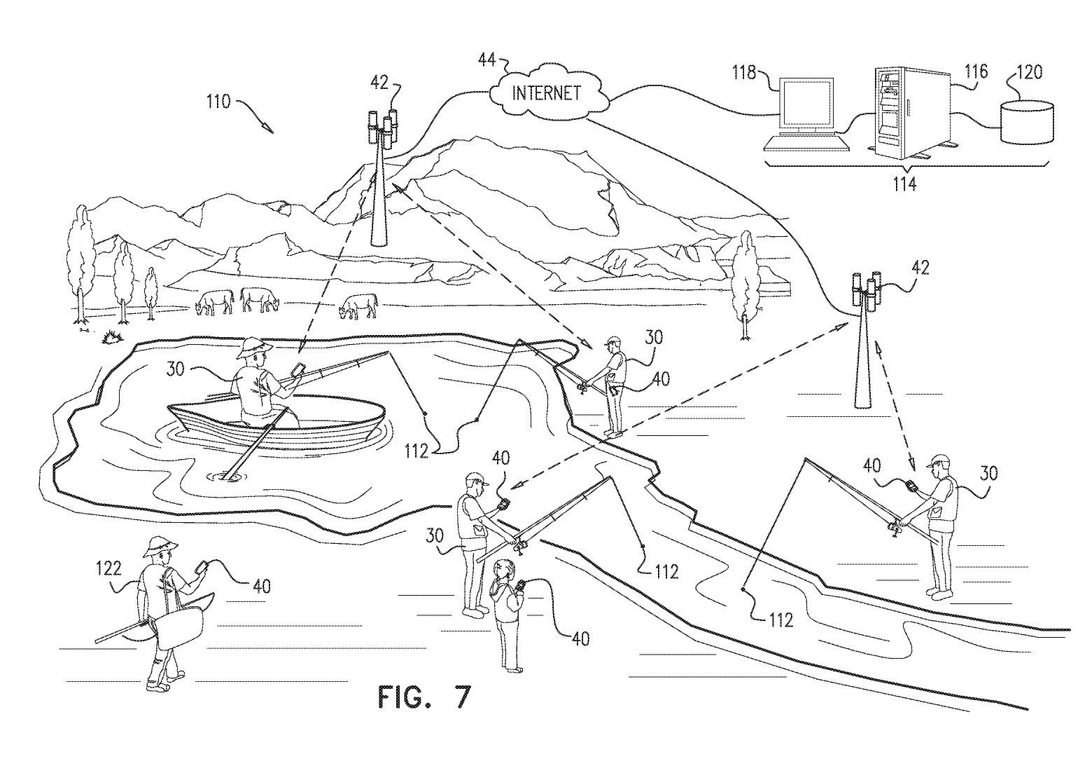

As noted earlier, in some embodiments of the present invention, mobile computing device 40 processes the signals from sensing device 22 in order to provide information to angler 30 in the form of textual, graphical, audio or haptic output from the user interface of device 40. Additionally or alternatively, device 40 transmits and receives data based on the processed signals over a wide-area network 44, such as the Internet. Typically, device 40 accesses network 44 via a cellular network 42 or other wireless data network. Access to network 44 can alternatively be established at a later stage when case there is no network coverage at the fishing location itself. Features and applications of this sort of wide-area data collection and distribution functionality are described further hereinbelow with reference to FIG. 7.

As is well known in the art, RF signals are strongly attenuated when passing through water. To overcome this difficulty in system 20, an antenna 38, such as a linear antenna, connected to device 22, is attached collinearly to fishing line 26. At the expected depth of deployment of device 22 below the surface of the water, the upper end of antenna 38 protrudes out of the water and is thus able to transmit and receive signals to and from mobile computing device 40 without excessive attenuation. Antenna 38 is “collinear” with fishing line 26 in the sense that it is aligned continuously along the line or curve defined by the fishing line, as shown in FIG. 1. For this purpose, antenna 38 may either be attached between the distal end of the fishing line and device 22, effectively as an extension of the fishing line, or coupled along the distal portion of the fishing line that connects to device 22. The wire from which antenna 38 is made is sufficiently lightweight and flexible so as not to substantially alter the feel and functionality of the fishing line.

The distal end of antenna 38 is connected to receive signals from the wireless communication interface in sensing device 22, while the proximal end of the linear antenna, opposite the distal end, protrudes above the surface of the water, as explained above, in order to transmit the signals to computing device 40 even when the sensing device is immersed below the surface. This sort of functionality is particularly useful with crankbait, which remains below the surface of the water. It is also useful, however, in conjunction with other sensing device configurations, such as floats, poppers and surface lures, to ensure good transmission quality even when the devices dip below the water surface.

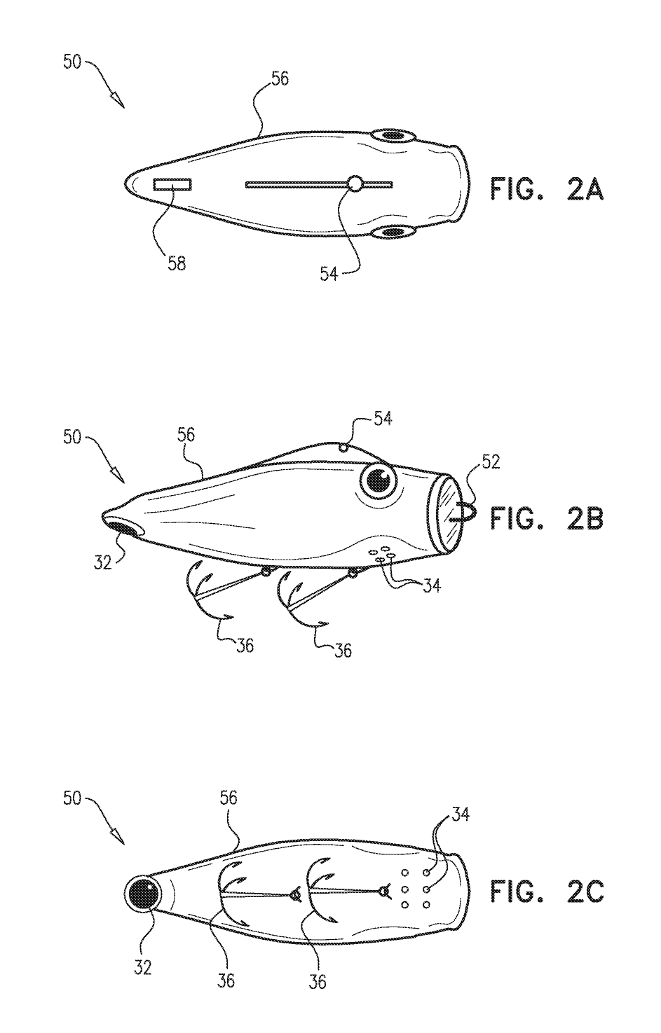

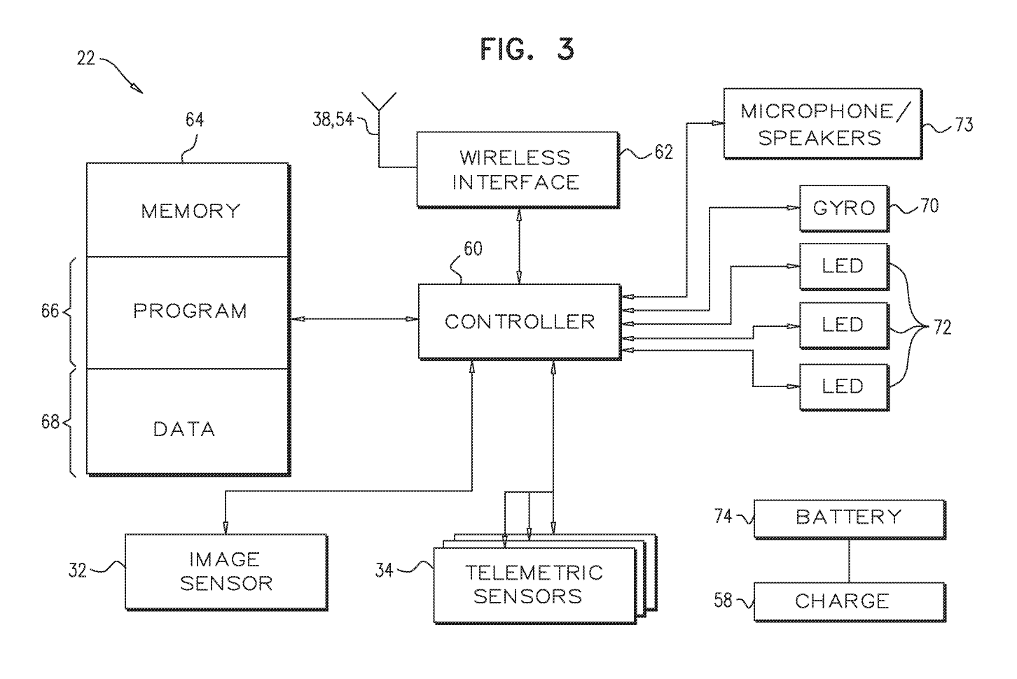

FIGS. 2A, 2B and 2C are schematic top, side, and bottom views, respectively, of an electronic artificial bait 50, in accordance with an embodiment of the invention. Bait 50 is configured as a sensing device, like device 22, with sensors 32 and 34, as described above, as well as hooks 36. In contrast to the preceding embodiment, bait 50 is configured as a popper, which floats on the water surface as it is trolled. Therefore, instead of external antenna 38, bait 50 comprises an integral antenna 54, with an eye 52 for tying to the distal end of a fishing line. Optionally, bait 50 comprises a sealed charging port 58 (possibly an inductive, non-contact port) for charging an internal battery, as shown in FIG. 3.

Bait 50 comprises a case 56, which has an external appearance chosen to attract fish in the water. The case may be colored with “fish-like” colors. In some embodiments, applicable not only to poppers but also to other types of surface and underwater bait, case 56 is translucent and contains a light source, such as one or more white or colored LEDs. The light source is controlled to emit light having a variable aspect so as to change the external appearance of the case. This feature can be applied to enhance the attractiveness of bait 50 to the particular type of fish that the angler is seeking to catch or suit the aquatic environment in which the angler is currently fishing. For example, the light source may be controlled to change its color and/or brightness. The appearance-changing functionality of bait 50 may be controlled by a switch (not shown) on the bait itself, and/or under the command of signals from an external transmitter, such as mobile computing device 40. Additionally or alternatively, bait 50 may contain one or more microphones and/or one or more speakers or other acoustic transducers for receiving sounds and/or generating acoustic vibrations that can be useful in attracting fish.

FIG. 3 is a block diagram that schematically illustrates functional components of an electronic artificial bait, such as device 22, in accordance with an embodiment of the invention. (Similar components are typically comprised in artificial bait 50, as well as in the other sorts of bait and immersible devices that are shown in the figures that follow). As explained earlier, telemetric sensors 34 in device 22 sense parameters relating to water quality. The term “water quality” should be broadly understood in this context and in the claims to include any and all characteristics of the water, as well as nearby objects in the water, into which the bait is cast. Thus, sensors 34 may sense, for example, water temperature; pH, salinity, oxygen, and/or other chemical parameters; nearby motion and/or vibration; and/or turbidity. An acoustic transducer 73 may be configured as a microphone to sense sound waves in the water. Alternatively or additionally, images captured by image sensor 32 may be analyzed to derive turbidity and other optical qualities of the water, as well as to detect the presence (or absence) of fish and possibly to identify the types and/or sizes and/or numbers of fish that are present. For these purposes, image sensor 32 may receive and sense visible or infrared light, or both.

Additionally, when device 22 is configured to float at the surface of the water, sensors 34 may comprise air quality, temperature, and weather sensors (not shown in the figures). Such sensors are typically mounted on the upper side of the device, rather than the lower side as shown in the figures. These sensors are useful both in providing local information to the angler and in gathering weather-related information from multiple locations over a wide area for transmission over network 44.

The functions of device 22 are controlled and coordinated by a controller 60, which is typically a single-chip component with suitable interfaces for connection to the other components of device 22. Controller 60 and at least some of the other components shown in FIG. 3 are typically mounted on a rigid or flexible printed circuit board (not shown) inside case 56. Controller 60 communicates with mobile computing device 40 via a wireless communication interface 62, such as a Wi-Fi or Bluetooth interface, for example, which is connected to antenna 38 or 54. A memory 64, comprising non-volatile memory (such as ROM and/or flash memory), and possibly volatile memory (such as RAM), as well, stores program code 66 to be run by controller 60 and data 68 collected by the controller from sensors 32, 34. Typically, controller 60 digitizes, pre-processes and may even process the outputs of sensors 32, 34 before transmitting digital signals carrying the data or the processed data to mobile computing device 40 via wireless interface 62. Alternatively, communication interface 62 may be configured to transmit the sensor outputs in analog form.

In embodiments in which device 22 is capable of changing its appearance by changes of internal lighting, this functionality is typically implemented using one or more light-emitting diodes (LEDs) 72 or other light emitters. For example, device 22 may comprise multiple LEDs 72 of different colors, which are actuated by controller 60 either autonomously (based on readings of sensors 32 and/or 34, for example) or under remote control via wireless interface 62. Each LED can be of a specific color or transmit different colors upon command. Additionally or alternatively, acoustic transducer 73 may be configured as a speaker to emit sounds or other vibrations for attracting fish to device 22.

In some embodiments, device 22 comprises a motion sensor 70, such as an accelerometer or other inertial sensor (commonly referred to as a “gyro”), which generates an output indicative of the motion of the device. Controller 60 transmits signals via interface 62 that are indicative of the output of motion sensor 70. Mobile computing device 40 receives and processes these signals in order to compute the trajectory of sensing device 22. An application, which runs either on device 40 or on a remote server (as shown in FIG. 7) in communication with device 40, analyzes the trajectory and provides information regarding the trajectory to angler 30. This trajectory analysis can provide feedback to the angler for help in improving his or her fishing technique. For example, the feedback may be directed to the manner in which the angler casts a lure over the water or trawls bait through the water.

Additionally or alternatively, this sort of trajectory analysis can be combined and synchronized with video data provided by image sensor 32 in order to enable machine vision processing by controller 60 to implement better and more exact motion-based algorithms, which use the trajectory analysis data in order to set and calibrate the image sensor movement.

Additionally or alternatively, mobile computing device 40 can process the output of motion sensor 70 in order to notify angler 30 promptly of events occurring at the end of fishing line 26. For this purpose, device 40 may analyze the motion sensor output along with images provided by image sensor 32. In this manner, device 40 can identify and alert the angler when a fish strikes or takes the bait, as well as when there are fish in the vicinity of the distal end of the line or when there is no bait left on the hook. The application running on device 40 may actuate any suitable user interface element to alert the angler to events of interest, such as an audio output, vibration, or display on the device screen.

Further additionally or alternatively, motion sensor 70 may comprise a location sensor, such as a GPS receiver. The output of the location sensor can be used to track the current location of device 22 and (with gross resolution) the motion of the device.

Further additionally or alternatively, sensors 32 and/or 34 may indicate locations that are statistically preferred by fishes according to specific water parameters, which can vary in some cases over distances as small as a few meters. On this basis, controller 60 may direct the angler to direct his casting to a different location in the same area in order to achieve better fishing results.

Controller 60 and the other components of device 22 or bait 50 are powered by a battery 74, which typically holds sufficient charge for at least several hours of continuous operation. Battery 74 may be rechargeable via charging port 56. Alternatively or additionally, battery 74 may be replaced by opening case 56 when the battery runs down. To extend the life of battery 74, the components of device 22 may switch on only when sensors 34 detect that the device is in the water and/or when actuated by the angler.

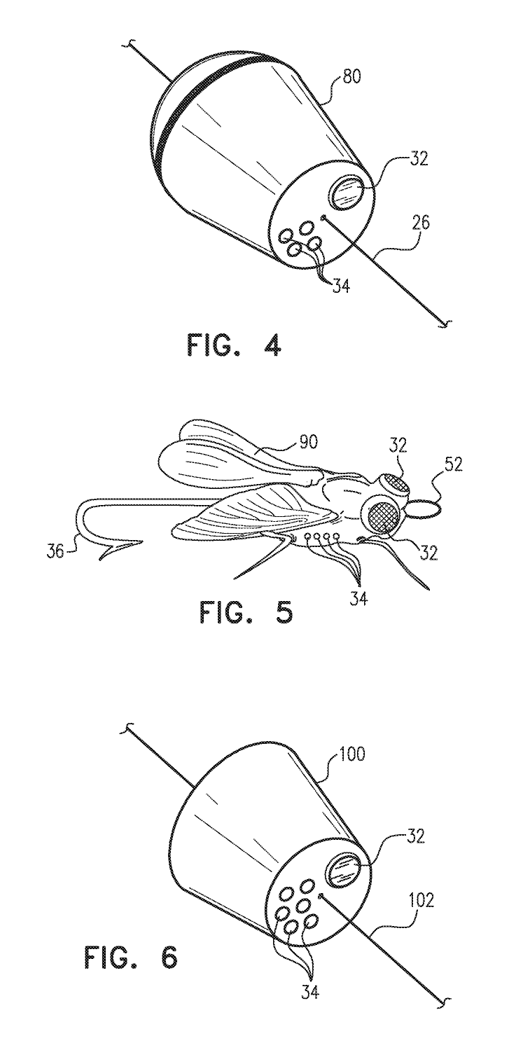

FIG. 4 is a schematic, pictorial illustration of an electronic float 80 for attachment to fishing line 26, in accordance with an embodiment of the invention. Float 80 supports a hook a short distance below the surface of the water, in a manner that emulates the operation of a conventional float. Float 80 contains sensors 32 and 34, as well as some or all of the other components that are shown in the preceding figures, and functions in a manner similar to that described above with reference to device 22. The electronic components are configured and packaged in float 80 in such a way as to minimize their impact on the mechanical characteristics of the device, so that its size, weight, buoyancy and moments resemble closely those of a conventional float.

FIG. 5 is a schematic, pictorial illustration of an electronic fly lure 90 for attachment to fishing line 26, in accordance with another embodiment of the invention. As in the preceding embodiment, lure 90 comprises sensors 32, 34 and other components (as in device 22), configured so as to minimize their impact on the angler's ability to cast the fly. A motion sensor, such as sensor 70 (FIG. 3) in lure 90 can be particularly useful in helping the angler to improve his or her casting technique. Specifically, since the fish strike vector in the case of a fly lure varies, lure 90 may comprise two or more image sensors 32, with optics configured to cover a wide viewing angle, up to a full 360°.

FIG. 6 is a schematic, pictorial illustration of an underwater sensing device 100 for deep-water fishing, in accordance with still another embodiment of the invention. Device 100 is connected to a fishing line 102 and may be oriented so that image sensor 32 captures images looking either down into deeper water or up toward the water surface, or both. In this embodiment, fishing line 102 typically comprises either a fine electrical cable or an optical fiber that carries signals output by device 100 back at least to the water surface, and possible all the way to the angler's fishing rod.

FIG. 7 is a schematic, pictorial illustration of a system 110 for electronic data collection, processing and exchange, in accordance with an embodiment of the invention. System 110 collects and processes information transmitted by mobile computing devices 40, belonging to anglers 30 who are distributed at different locations along bodies of water over a wide geographical area. Anglers 30 deploy respective immersible sensing devices 112, with the sorts of shapes and features described above with reference to the preceding figures. Computing devices 40 both transmit data collected by the respective sensing devices 112 over the air to network 44 and present information and recommendations to anglers 30, based on the data that they gather locally from the sensing devices and/or information that they receive from network 44. Multicast capabilities also enable multiple users at the same site to view data simultaneously on their respective computing devices 40.

A server 114 receives and processes information transmitted by mobile computing devices 40. Server 114 typically comprises a general-purpose computer, which comprises a processor 116 with a suitable interface 118 to network 44 and a memory 120. Processor 116 carries out the functions that are described herein under the control of software, which is typically stored in tangible, non-transitory computer-readable media, such as optical, magnetic, or electronic memory media. The application software that enables the processors (not shown) in mobile computing devices 40 to carry out their functions, as described herein, is typically similarly stored in such media, as well.

Server 114 receives various different kinds of data from sensing devices 112 in system 110. For example, sensing devices 112 may transmit, via mobile computing devices 40, images that they capture below the surface of the water. Server 114 may also receive other sorts of data from devices 40, such as GPS-based location data. Server 114 analyzes the images to identify and count the fish captured by the image sensors in the sensing devices. The server may apply this analysis, along with location information provided by the sensing and/or mobile computing devices, in mapping the distribution of fish over the coverage area. On this basis, server 114 can distribute information over network 44 that indicates to anglers, such as an angler 122 who is joining the system, where to find favorable locations for catching fish. (Additionally or alternatively, as noted earlier, mobile computing device 40 may also provide such indications locally, with finer resolution, to recommend nearby locations where the angler using device 40 should drop or cast his or her line.)

As another example, mobile computing devices 40 may collect and transmit data to server 114 based on the outputs of sensors 34 with respect to local water quality. In this case, server 114 can analyze the sensor data so as to provide a map of environmental quality over the area of system 110. This map can be used both in directing anglers to fishing locations that appear to be favorable in terms of water conditions and for more general purposes of water quality monitoring and protection. In this latter context, when large numbers of anglers participate, system 110 acts as a large-scale, wide-area environmental monitoring network that can provide data with higher resolution and sensitivity than sensor networks that are currently deployed, while the costs of deployment are covered almost entirely by the anglers themselves. If sensing devices 112 (and/or mobile computing devices 40) are also equipped with sensors for measuring weather-related parameters, system 110 can be useful in weather forecasting, as well. An incentive-based program can incentivize anglers to go fishing in locations where this large-scale, wide-area environmental monitoring network is missing some critical data.

Server 114 and the fishing application running on mobile computing devices 40 in system 110 may provide a wide range of added-value services to anglers 30, both before, during, and after fishing. These services may be integrated in a social network of anglers, which enables them to share information and advice, arrange places to meet and competitions, and share and compare fishing results. Various services and features that can be implemented in system 110 are described in greater detail, for example, in the above-mentioned provisional patent applications.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Angling apparatus, comprising:
an immersible sensing device, which is configured for attachment to a distal end of a fishing line and contains one or more sensors and a wireless communication interface coupled to transmit signals indicative of an output of the one or more sensors; and
a linear antenna, which has a first end connected to receive signals from the wireless communication interface, and which is configured to be attached collinearly to the fishing line so that while the sensing device is immersed below a surface of a body of water, a second end of the linear antenna, opposite the first end, protrudes above the surface in order to transmit the signals.

2. The apparatus according to claim 1, wherein the immersible sensing device is configured as an artificial bait.

3. The apparatus according to claim 2, wherein the artificial bait comprises a crankbait.

4. The apparatus according to claim 1, wherein the one or more sensors comprise an image sensor, which is configured to capture images below the surface.

5. The apparatus according to claim 1, wherein the output of at least one of the sensors is indicative of a quality of the water.

6. The apparatus according to claim 1, wherein at least one of the sensors comprises an accelerometer.

7. The apparatus according to claim 1, wherein the wireless communication interface is configured to transmit the signals via the antenna over the air to a receiver using a short-range radio-frequency (RF) communication protocol.

8. The apparatus according to claim 7, and comprising a mobile computing device, which comprises the receiver and is configured to process the signals and to provide, responsively to the processed signals, information to an angler operating the apparatus.

9. Angling apparatus, comprising an artificial bait, which is configured for immersion in water and comprises:
a case, which has an appearance chosen to attract a fish in the water and is configured to be attached to a fishing line;
a motion sensor, contained within the case and configured to generate an output indicative of motion of the artificial bait; and
a communication interface, contained within the case and coupled to transmit signals indicative of the output of the motion sensor.

10. The apparatus according to claim 9, and comprising an antenna attached to the case, wherein the communication interface is coupled to transmit the signals over the air via the antenna.

11. The apparatus according to claim 9, and comprising a mobile computing device, which is configured to receive and process the signals transmitted by the communication interface so as to present an analysis of a trajectory of the artificial bait to an angler using the apparatus.

12. The apparatus according to claim 9, and comprising an image sensor, which is contained in the case and configured to capture images under a surface of the water.

13. Angling apparatus, comprising an artificial bait, which is configured for immersion in water and comprises:
a translucent case, which has an external appearance chosen to attract a fish in the water and is configured to be attached to a fishing line; and
a light source, which is contained inside the case, and is controllable to emit light having a variable aspect so as to change the external appearance of the case.

14. The apparatus according to claim 13, wherein the variable aspect of the light source comprises a variable color of the emitted light.

15. The apparatus according to claim 13, and comprising:
a communication interface, which is contained within the case and is coupled to receive command signals from a transmitter external to the artificial bait; and
a controller, which is coupled to alter the variable aspect of the light source responsively to the command signals.

16. The apparatus according to claim 13, and comprising an acoustic transducer, which is contained inside the case and is configured to perform at least one of transmitting and receiving acoustic vibrations in the water.

17. A system for angling, comprising:
at least one immersible sensing device, containing one or more sensors and a wireless communication interface coupled to transmit signals indicative of an output of the one or more sensors, for deployment at a distal end of a fishing line by an angler into a body of water; and
a processor, which is coupled to receive the signals transmitted by the at least one immersible sensing device over the air and to process the signals so as to present a recommendation with regard to the angling.

18. The system according to claim 17, wherein the processor is contained in a mobile computing device, which is configured to receive the signals over the air from the at least one immersible sensing device.

19. The system according to claim 17, wherein the at least one immersible sensing device is configured as an artificial bait.

20. The system according to claim 19, wherein at least one of the sensors comprises an accelerometer, and wherein the processor is configured to analyze a trajectory of the artificial bait and to present advice to the angler, responsively to the trajectory, with regard to an angling technique.

21. The method according to claim 17, wherein the one or more sensors comprise an image sensor, which is configured to capture images below the surface, and wherein the processor is configured to process images of fish captured by the image sensor.

22. The method according to claim 21, wherein the processor is configured to direct the angler, based on the processed images, to a location for catching fish.

23. The method according to claim 22, wherein the at least one immersible sensing devices comprises multiple immersible sensing devices for deployment by multiple anglers at different, respective locations, and
wherein the processor is configured to receive data from the multiple immersible sensing devices and to process the images captured at the different locations so as to provide an indication of the location for catching fish.

24. The method according to claim 17, wherein the output of at least one of the sensors is indicative of a quality of the water.

25. The method according to claim 24, wherein the at least one immersible sensing devices comprises multiple immersible sensing devices for deployment by multiple anglers at different, respective locations, and
wherein the processor is configured to receive data from the multiple immersible sensing devices and to analyze the data so as to provide a map of environmental quality over an area containing the locations.

26. A method for angling, comprising:
providing at least one immersible sensing device, containing one or more sensors and a wireless communication interface coupled to transmit signals indicative of an output of the one or more sensors, for deployment at a distal end of a fishing line by an angler into a body of water;
receiving the signals transmitted by the at least one immersible sensing device over the air in a mobile computing device carried by the angler; and
processing the signals so as to present a recommendation with regard to the angling.

27. The method according to claim 26, wherein the at least one immersible sensing device is configured as an artificial bait.

28. The method according to claim 27, wherein at least one of the sensors comprises an accelerometer, and wherein processing the signals comprises analyzing a trajectory of the artificial bait and presenting advice to the angler, responsively to the trajectory, with regard to an angling technique.

29. The method according to claim 26, wherein the one or more sensors comprise an image sensor, which is configured to capture images below the surface, and wherein processing the signals comprises processing images of fish captured by the image sensor.

30. The method according to claim 29, wherein processing the signals comprises directing the angler, based on the processed images, to a location for catching fish.

31. The method according to claim 30, wherein providing the at least one immersible sensing devices comprises providing multiple immersible sensing devices for deployment by multiple anglers at different, respective locations, and
wherein directing the angler comprises receiving data from multiple mobile computing devices operated by the multiple anglers, and analyzing the images captured at the different locations so as to provide an indication of the location for catching fish.

32. The method according to claim 31, wherein the output of at least one of the sensors is indicative of a quality of the water.

33. The method according to claim 32, wherein providing the at least one immersible sensing devices comprises providing multiple immersible sensing devices for deployment by multiple anglers at different, respective locations, and
wherein the method comprises receiving data from multiple mobile computing devices operated by the multiple anglers, and analyzing the data so as to provide a map of environmental quality over an area containing the locations.

34. A method for angling, comprising:
attaching to a distal end of a fishing line an immersible sensing device containing one or more sensors and a wireless communication interface coupled to transmit signals indicative of an output of the one or more sensors;
connecting a first end of a linear antenna to receive signals from the wireless communication interface; and
attaching the linear antenna collinearly to the fishing line so that while the sensing device is immersed below a surface of a body of water, a second end of the linear antenna, opposite the first end, protrudes above the surface in order to transmit the signals.

35. The method according to claim 34, wherein the immersible sensing device is configured as an artificial bait.

36. The method according to claim 35, wherein the artificial bait comprises a crankbait.

37. The method according to claim 34, wherein the one or more sensors comprise an image sensor, which is configured to capture images below the surface.

38. The method according to claim 34, wherein the output of at least one of the sensors is indicative of a quality of the water.

39. The method according to claim 34, wherein at least one of the sensors comprises an accelerometer.

40. The method according to claim 34, and comprising transmitting the signals via the antenna over the air to a receiver using a short-range radio-frequency (RF) communication protocol.

41. The method according to claim 40, and comprising receiving and processing the signals in a processor outside the water, and providing, responsively to the processed signals, information to an angler operating the immersible sensing device.

42. A method for angling, comprising:
providing an artificial bait, which is configured for immersion in water and comprises a case, which has an appearance chosen to attract a fish in the water and is configured to be attached to a fishing line, and a motion sensor, contained within the case and configured to generate an output indicative of motion of the artificial bait; and
transmitting signals indicative of the output of the motion sensor from the artificial bait to a receiver outside the water.

43. The method according to claim 42, wherein transmitting the signals comprises transmitting the signals over the air from an antenna attached to the case.

44. The method according to claim 42, and comprising receiving and processing the signals transmitted from the artificial bait so as to present an analysis of a trajectory of the artificial bait to an angler using the fishing line.

45. The method according to claim 42, and comprising capturing images under a surface of the water using an image sensor, which is contained in the case of the artificial bait.

46. A method for angling, comprising:
providing an artificial bait, which is configured for immersion in water and comprises a translucent case, which has an external appearance chosen to attract a fish in the water and is configured to be attached to a fishing line; and
controlling a light source, which is contained inside the case, to emit light having a variable aspect so as to change the external appearance of the case.

47. The method according to claim 46, wherein the variable aspect of the light source comprises a variable color of the emitted light.

48. The method according to claim 46, wherein controlling the light source comprises receiving command signals from a transmitter external to the artificial bait, and altering the variable aspect of the light source responsively to the command signals.

49. The method according to claim 46, and comprising applying an acoustic transducer, which is contained inside the case, to perform at least one of transmitting and receiving acoustic vibrations in the water.
